(19) United States
(12) Patent Application Publication
(10) Pub. No.: US 2008/0215870 A1
(43) Pub. Date: Sep. 4, 2008

(54) Method and apparatus for loading boot code

(76) Inventor: Hua Peng Liew, Sigapore (SG)

Correspondence Address: COLLARD & ROE, P.C., 1077 NORTHERN BOULEVARD, ROSLYN, NY, 11576, US

(21) Appl. No.: 10/704,239

(22) Filed: Nov. 6, 2003

(30) Foreign Application Priority Data
Nov. 7, 2002 (SG) 200206739-5

(51) Int. Cl. G06F 9/24

(52) U.S. Cl. 713/2

(57) ABSTRACT

Apparatus for loading boot code including a non-volatile memory for the storage of the boot code, a micro-control unit for the storage of a small boot code, a microprocessor, and a volatile memory; and wherein the microprocessor copies the boot code from the non-volatile memory into the volatile memory using the small boot code. A corresponding method is also disclosed.

### FIELD OF THE INVENTION

The present invention relates to a method and apparatus for the loading of boot code for a microprocessor and refers particularly, though not exclusively, to a method and apparatus of loading boot code stored in NAND Flash memory.

### BACKGROUND TO THE INVENTION

Boot code is the first piece of code loaded and executed by a microprocessor. The boot code resides in a known location of memory and the microprocessor executes the boot code at the known location. Boot code is normally stored in non-volatile memory such as, for example, EPROM, ROM or NOR Flash as it can't be lost and needs to be present even after a power loss.

Microprocessor systems also need volatile memory (such as, for example, RAM) to store variables and changeable data. As such, microprocessor systems have both volatile and non-volatile memory.

A low-cost form of non-volatile Flash memory is available—NAND Flash. Although it is of very low cost, and is therefore attractive to equipment manufacturers, it has not been extensively used as it has a limited interface. It's contents cannot be addressed and read individually but must be read as a block. This prevents it from being used as non-volatile memory holding boot code that needs to be read and executed directly by the microprocessor. One method developed to overcome this is illustrated in FIG. 1. An external ASIC is used to maintain the microprocessor in the Reset state while it reads code from the NAND Flash. The ASIC copies the entire code into the RAM before releasing the Reset, thereby allowing the microprocessor to execute the code from the RAM.

### SUMMARY OF THE INVENTION

In accordance with a preferred aspect of the invention there is provided apparatus for loading boot code including a non-volatile memory for the storage of the boot code, a micro-control unit for the storage of a small boot code, a microprocessor, and a volatile memory; and wherein the microprocessor copies the boot code from the non-volatile memory into the volatile memory using the small boot code.

Preferably, the small boot code is storable in a part of the volatile memory reserved for the boot code, and is for controlling the microprocessor to copy the boot code from the non-volatile memory into the volatile memory.

The microprocessor may have a serial port and a Serial-to-RAM logic block. The micro-control unit may be for asserting a setup pin on power-on to enable the Serial-to-RAM logic block to receive a special code from the serial port. The Serial-to-RAM logic block may be for loading the small boot code from the micro-control unit into the volatile memory.

Alternatively, the microprocessor may have a JTAG interface and data address and control pins. The micro-control unit may be for asserting a RESET pin to maintain the microprocessor in a RESET state to enable the micro-control unit to write the small boot code into the volatile memory. The RESET pin may be de-asserted to enable the microprocessor to operate normally under the control of the small boot code to copy the boot code from the non-volatile memory into the volatile memory.

After the boot code is copied into the volatile memory the microprocessor may be operable normally under the control of the boot code. The non-volatile memory may be a NAND Flash memory, and the volatile memory may be RAM.

In another preferred form, there is provided a method for loading boot code stored in a non-volatile memory, including activating a micro-control unit having a small boot code stored therein, and using a microprocessor to load the boot code from the non-volatile memory into a volatile memory using the small boot code.

The small boot code may be stored in a part of the volatile memory reserved for the boot code, and the small boot code may control the microprocessor to copy the boot code from the non-volatile memory into the volatile memory.

The microprocessor may have a serial port and a Serial-to-RAM logic block. The micro-control unit may assert a setup pin on power-on to enable the Serial-to-RAM logic block to receive a special code from the serial port. The Serial-to-RAM logic block may load the small boot code from the micro-control unit into the volatile memory.

Alternatively, the microprocessor may have a JTAG interface and data address and control pins. The micro-control unit may assert a RESET pin to maintain the microprocessor in a RESET state to enable the micro-control unit to write the small boot code into the volatile memory. The RESET pin may be de-asserted to enable the microprocessor to operate normally under the control of the small boot code to copy the boot code from the non-volatile memory into the volatile memory.

After the boot code is copied into the volatile memory the microprocessor may operate normally under the control of the boot code.

There is also provided a computer when fitted with such apparatus as described above; and when used to perform the method as described above; and a computer useable medium comprising a computer program code that is configured to cause a processor to execute one or more functions as described above; and a computer system that comprises one or more means for performing corresponding one or more functions as described above.

### DESCRIPTION OF THE DRAWINGS

In order that the invention may be better understood and readily put into practical effect there shall now be described by way of non-limitative example only preferred embodiments of the present invention, the description being with reference to the accompanying illustrative drawings in which:

FIG. 1 is a block diagram showing the present state of the art;

FIG. 2 is a block diagram of a first embodiment incorporating the present invention at a first state;

FIG. 3 is a block diagram of the first embodiment at a second state;

FIG. 4 is a block diagram of the first embodiment at a third state;

FIG. 5 is a flow chart for the method of the first embodiment;

FIG. 6 is a block diagram of a second embodiment incorporating the present invention at a first state;

FIG. 7 is a block diagram of the second embodiment at a second state; and

FIG. 8 is a flow chart for the method of the second embodiment.

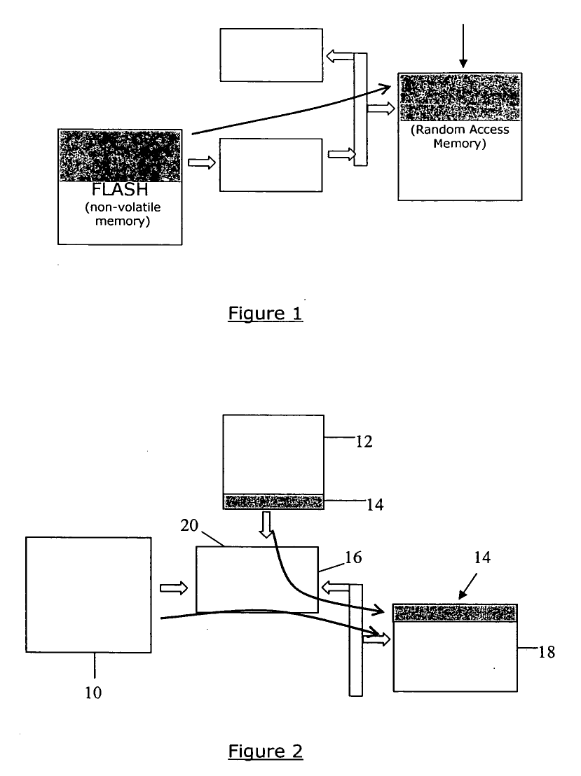

### DESCRIPTION OF THE PREFERRED EMBODIMENTS

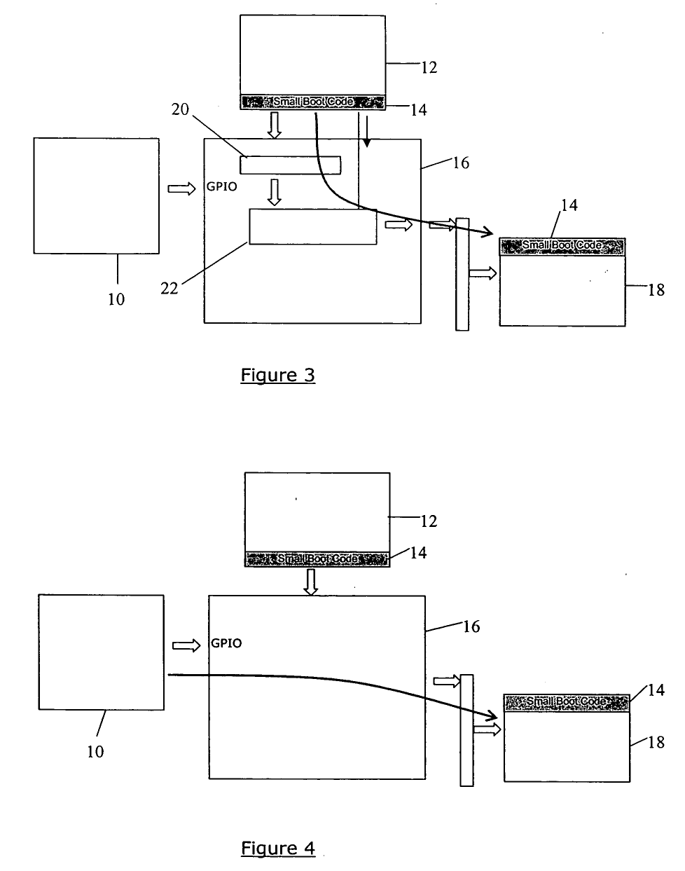

To first refer to FIGS. 2 to 4, there is shown NAND Flash memory 10, a micro-control unit 12 having a small boot code 14 built-in and stored in its internal ROM, microprocessor 16, and RAM 18.

The micro-control unit 12 is a relatively simple microprocessor such as an 8-bit microprocessor. As such, it would be relatively inexpensive. It may have a number of functions such as, for example, ten functions, and has a connector, preferably a serial port.

The microprocessor 16 also has a serial port 20 and a Serial-to-RAM logic block 22. When power is initially applied, a setup pin is applied. The Serial-to-RAM logic block 22 then starts, but only when the setup pin is applied. During the power-on stage, the micro-control unit 12 asserts the setup pin; and the Serial-to-RAM logic block 22 waits for a special code to be received from the serial port 20 to activate the next stage or mode. This special code may be, for example, ASCII “U”. When the special code is received, the Serial-to-RAM logic block 22 then waits for the small boot code data 14 to be sent by the micro-control unit 12. When the data is sent, it is written into the RAM 18 by the Serial-to-RAM logic block 22. The data is written in the RAM 18 in the location 24 reserved for boot code.

The Serial-to-RAM logic block 22 is then disabled be de-asserting the setup pin. The microprocessor then runs as per normal. As the small boot code 14 is in the boot code location 24, it is executed by the microprocessor 16 and the small boot code 14 has control of the microprocessor 16.

The small boot code 14 then copies data from the NAND Flash 10 to the RAM 18. The data copied includes the operating system and application programs. Once copying is complete, control passes to the operating system.

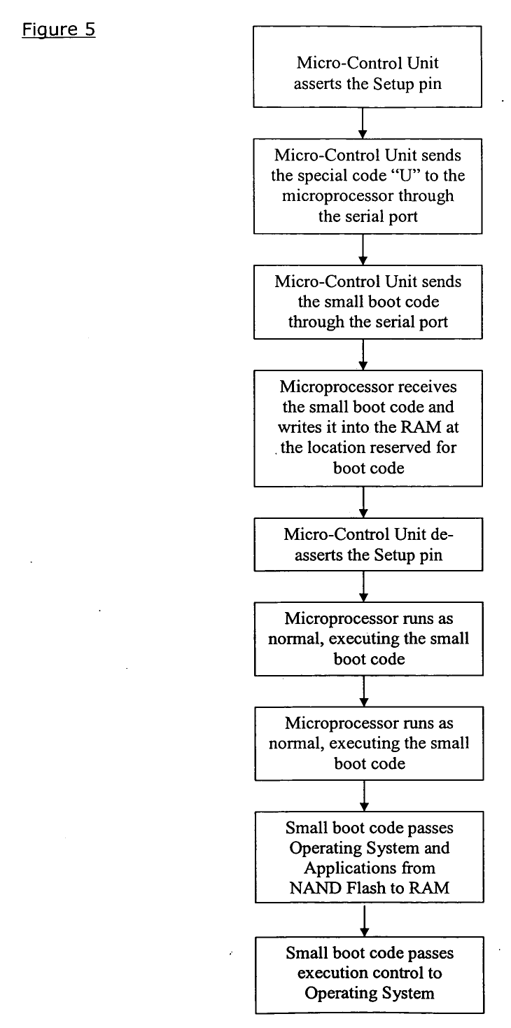

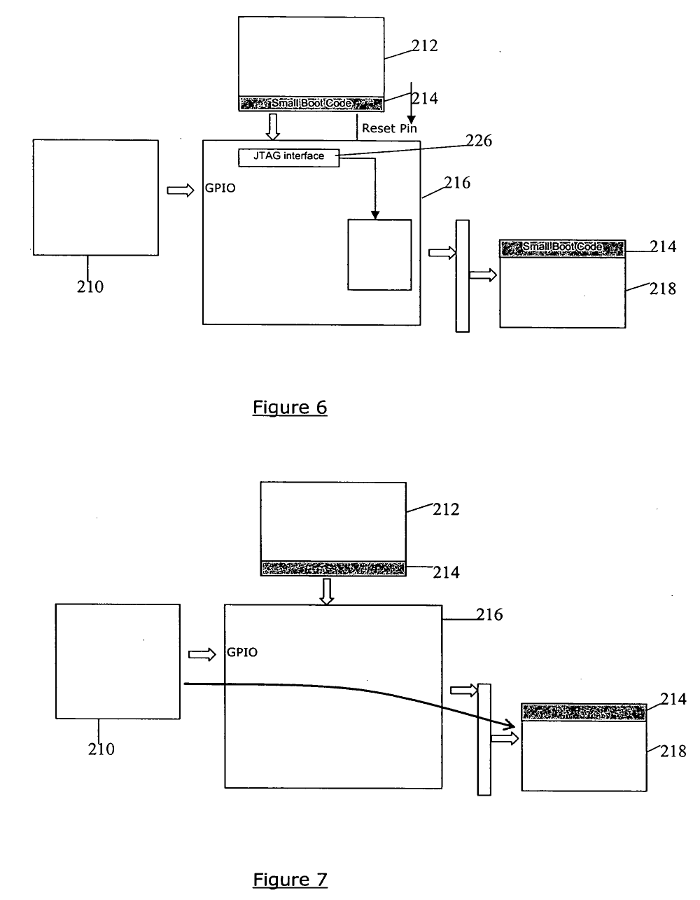

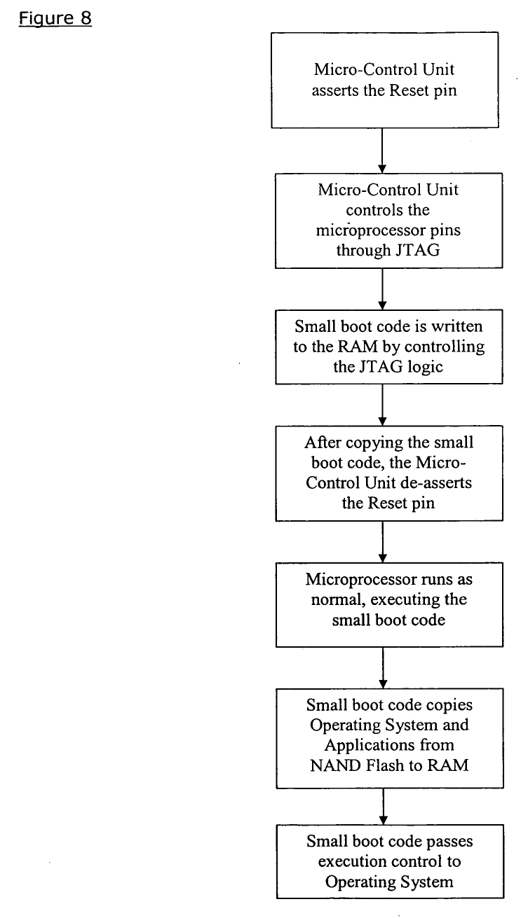

In FIGS. 5 and 6 there is shown a variation. Here the same reference numerals are used for like components but with a prefix number of 2 indicating a second embodiment. Here, a JTAG interface 226 is used in the microprocessor 216. The JTAG interface 226 has special pins on the integrated circuit that are daisy-chained to all other pins on the integrated circuit by the use of special logic. This allows an external device to shift data to all the pins of the integrated circuit and, at a given signal, latch the data onto the pins. It also allows the actual data on the integrated circuit pins to be read at the same time and to be shifted to an external device. The JTAG interface allows the external device to read data on all the integrated circuit pins and to write any data onto the same pins.

As before, the micro-control unit 212 asserts the RESET pin to maintain the microprocessor 216 in the RESET state. Using the JTAG interface 226, the microprocessor 216 then shifts data into the microprocessor 216 to control the microprocessor 216 pins. Using that method, the micro-control unit 212 writes the small boot code 214 into the RAM 218. The RESET pin is then de-asserted and the microprocessor 216 executes normally with the small boot code 214 controlling the microprocessor 216. The small boot code 214 then copies data from the NAND Flash 210 to the RAM 218. The data copied includes the operating system and application programs. Once copying is complete, control passes to the operating system.

In this way, the NAND Flash copying function can be performed with minimal additional system cost. Most embedded microprocessor systems have an external micro-control unit to perform such functions as power management and so forth. As the NAND Flash copying function is used only at booting, when most other functions for the micro-control unit are not required, it should not add additional processing burdens to the micro-control unit. As most micro-control units have ample data storage they should easily cope with the storage of the small boot code.

Furthermore, most microprocessors have a Serial-to-RAM logic block for such functions as code development and code debugging; and most integrated circuits have a JTAG interface for production testing of the integrated circuit.

Whilst there has been described in the foregoing description preferred embodiments of the present invention, it will be understood by those skilled in the technology that many variations or modifications in details of design, construction or operation may be made without departing from the present invention.

The present invention extends to all features disclosed both individually and in all possible permutations and combinations.

1. Apparatus for loading boot code including a non-volatile memory for the storage of the boot code, a micro-control unit for the storage of a small boot code, a microprocessor, and a volatile memory; and wherein the microprocessor copies the boot code from the non-volatile memory into the volatile memory using the small boot code.

2. Apparatus as claimed in claim 1, wherein the small boot code is storable in a part of the volatile memory reserved for the boot code.

3. Apparatus as claimed in claim 1, wherein the small boot code is for controlling the microprocessor to copy the boot code from the non-volatile memory into the volatile memory.

4. Apparatus as claimed in claim 1, wherein the microprocessor has a serial port and a Serial-to-RAM logic block.

5. Apparatus as claimed in claim 4, wherein the micro-control unit is for asserting a setup pin on power-on to enable the Serial-to-RAM logic block to receive a special code from the serial port.

6. Apparatus as claimed in claim 4, wherein the Serial-to-RAM logic block is for loading the small boot code from the micro-control unit into the volatile memory.

7. Apparatus as claimed in claim 1, wherein the microprocessor has a JTAG interface and data address and control pins.

8. Apparatus as claimed in claim 7, wherein the micro-control unit is for asserting a RESET pin to maintain the microprocessor in a RESET state to enable the micro-control unit to write the small boot code into the volatile memory.

9. Apparatus as claimed in claim 7, wherein the RESET pin is, in use, de-asserted to enable the microprocessor to operate normally under the control of the small boot code to copy the boot code from the non-volatile memory into the volatile memory.

10. Apparatus as claimed in claim 6, wherein after the boot code is copied into the volatile memory the microprocessor is operable normally under the control of the boot code.

11. Apparatus as claimed in claim 9, wherein after the boot code is copied into the volatile memory the microprocessor is operable normally under the control of the boot code.

12. Apparatus as claimed in claim 1, wherein the non-volatile memory is a NAND Flash memory.

13. Apparatus as claimed in claim 1, wherein the volatile memory is RAM.

14. A method for loading boot code stored in a non-volatile memory, including activating a micro-control unit having a small boot code stored therein, and using a microprocessor to load the boot code from the non-volatile memory into a volatile memory using the small boot code.

15. A method as claimed in claim 14, wherein the small boot code is stored in a part of the volatile memory reserved for the boot code.

16. A method as claimed in claim 14, wherein the small boot code controls the microprocessor to copy the boot code form the non-volatile memory into the volatile memory.

17. A method as claimed in claim 14, wherein the microprocessor has a serial port and a Serial-to-RAM logic block.

18. A method as claimed in claim 17, wherein the micro-control unit asserts a setup pin on power-on to enable the Serial-to-RAM logic block to receive a special code from the serial port.

19. A method as claimed in claim 17, wherein the Serial-to-RAM logic block loads the small boot code from the micro-control unit into the volatile memory.

20. A method as claimed in claim 14, wherein the microprocessor has a JTAG interface and data address and control pins.

21. A method as claimed in claim 20, wherein the micro-control unit asserts a RESET pin to maintain the microprocessor in a RESET state to enable the micro-control unit to write the small boot code into the volatile memory.

22. A method as claimed in claim 20, wherein the RESET pin is de-asserted to enable the microprocessor to operate normally under the control of the small boot code to copy the boot code from the non-volatile memory into the volatile memory.

23. A method as claimed in claim 22, wherein after the boot code is copied into the volatile memory the microprocessor operates normally under the control of the boot code.

24. A method as claimed in claim 19, wherein after the boot code is copied into the volatile memory the microprocessor operates normally under the control of the boot code.

25. A method as claimed in claim 14, wherein the non-volatile memory is a NAND Flash memory.

26. A method as claimed in claim 21, wherein the small boot code is written into the volatile memory via the JTAG interface of the microprocessor.

27. A method as claimed in claim 14, wherein the volatile memory is RAM.

28. A computer when fitted with apparatus as claimed in claim 1.

29. A computer when used to perform the method of claims 14.

30. A computer useable medium comprising a computer program code that is configured to cause a processor to execute one or more functions as claimed in claim 14.
